(19) United States
(12) Patent Application Publication
(10) Pub. No.: US 2025/0261288 A1
(43) Pub. Date: Aug. 14, 2025

(54) TAILORED LEVELING TEMPERATURE FOR LOW TEMPERATURE EXPANSION IRON NICKEL ALLOYS

(71) Applicant: The Boeing Company, Arlington, VA (US)

(72) Inventors: Marc Rollo Matsen, Seattle, WA (US); Gwendolyn Marie Janda, Seattle, WA (US); John Ralph Hull, Seattle, WA (US); Landon Keith Henson, Snoqualmie, WA (US)

(21) Appl. No.: 19/016,781

(22) Filed: Jan. 10, 2025

Related U.S. Application Data
(60) Provisional application No. 63/552,469, filed on Feb. 12, 2024.

(51) Int. Cl. H05B 6/10; C22C 19/05; H05B 1/02; H05B 6/08

(52) U.S. Cl. CPC H05B 6/105; C22C 19/058; H05B 1/0247; H05B 6/08; H05B 2206/023

(57) ABSTRACT

Methods of manufacture and use of an induction tool are presented. A thermoplastic induction tool comprises an inductive heating element formed of a low thermal expansion iron nickel alloy magnetically poisoned by a non-ferromagnetic agent to have a leveling temperature selected based on a consolidation temperature of a composite material.

### CROSS-REFERENCE TO RELATED APPLICATION

This application claims the benefit of U.S. Provisional Patent Application Ser. No. 63/552,469, filed Feb. 12, 2024, and entitled “Tailored Leveling Temperature for Low Temperature Expansion Iron Nickel Alloys,” which is incorporated herein by reference in its entirety.

### BACKGROUND INFORMATION

### 1. Field

The present disclosure relates generally to inductive heating and more specifically to controlling the leveling temperature for a low temperature expansion iron nickel alloy.

### 2. Background

Induction heating may be used in a wide variety of industrial processes to elevate the temperature of parts or structures. For example, in the field of composites, induction heating may be used to cure one or more portions of a structure formed from composite materials such as fiber reinforced polymer resins. In order to achieve thermal uniformity during the heating process, an induction heating system may use induction coils magnetically coupled with susceptors to translate electrical power into heat energy. The susceptors are sometimes referred to as “smart” susceptors because the materials from which they are formed are specifically chosen to produce a maximum, constant temperature when inductively heated. This equilibrium constant temperature is achieved at the Curie point of the susceptor material. The Curie Point is the temperature at which there is a transition between the ferromagnetic and nonmagnetic phases of the material. Once the Curie temperature is reached, the susceptors become non-magnetic and greatly reduce their heating rate. This built-in thermostatic control provides a means of avoiding overheating and allows precise temperature control. The susceptors may be in various physical forms, including but not limited to sleeves or spiral warps placed around induction coils, plates, or magnetic particles dispersed within a surrounding matrix.

Therefore, it would be desirable to have a method and apparatus that takes into account at least some of the issues discussed above, as well as other possible issues.

### SUMMARY

An embodiment of the present disclosure provides a thermoplastic induction tool. The thermoplastic induction tool comprises an inductive heating element formed of a low thermal expansion iron nickel alloy magnetically poisoned by a non-ferromagnetic agent to have a leveling temperature selected based on a consolidation temperature of a composite material.

Another embodiment of the present disclosure provides a method of forming a composite material. Heat is inductively generated in a susceptor in a thermoplastic induction tool until the susceptor reaches its leveling temperature, the susceptor comprising a low thermal expansion iron nickel alloy magnetically poisoned by a non-ferromagnetic agent to set its leveling temperature. The composite material is conductively heated in the thermoplastic induction tool by heat generated by the susceptor. Pressure is applied to the composite material to consolidate the composite material within the thermoplastic induction tool.

Yet another embodiment of the present disclosure provides a method of forming a thermoplastic induction tool. A non-ferromagnetic agent is added to a low thermal expansion iron nickel alloy to magnetically poison the low thermal expansion iron nickel alloy. The low thermal expansion iron nickel alloy magnetically poisoned by the non-ferromagnetic agent is shaped into a shape of a smart susceptor. The smart susceptor is attached to a first contoured surface of a first tooling die.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a graph of the relationship between chromium and the leveling temperature of ASTM F15 in accordance with an illustrative embodiment;

FIG. 4 is an illustration of a cross-sectional view of a thermoplastic induction tool having a susceptor with a non-ferromagnetic agent in accordance with an illustrative embodiment;

FIG. 5 is a flowchart of a method of forming a composite material in accordance with an illustrative embodiment;

FIG. 6 is a flowchart of a method of forming a thermoplastic induction tool in accordance with an illustrative embodiment;

FIG. 7 is an illustration of an aircraft manufacturing and service method in a form of a block diagram in accordance with an illustrative embodiment; and

FIG. 8 is an illustration of an aircraft in a form of a block diagram in which an illustrative embodiment may be implemented.

### DETAILED DESCRIPTION

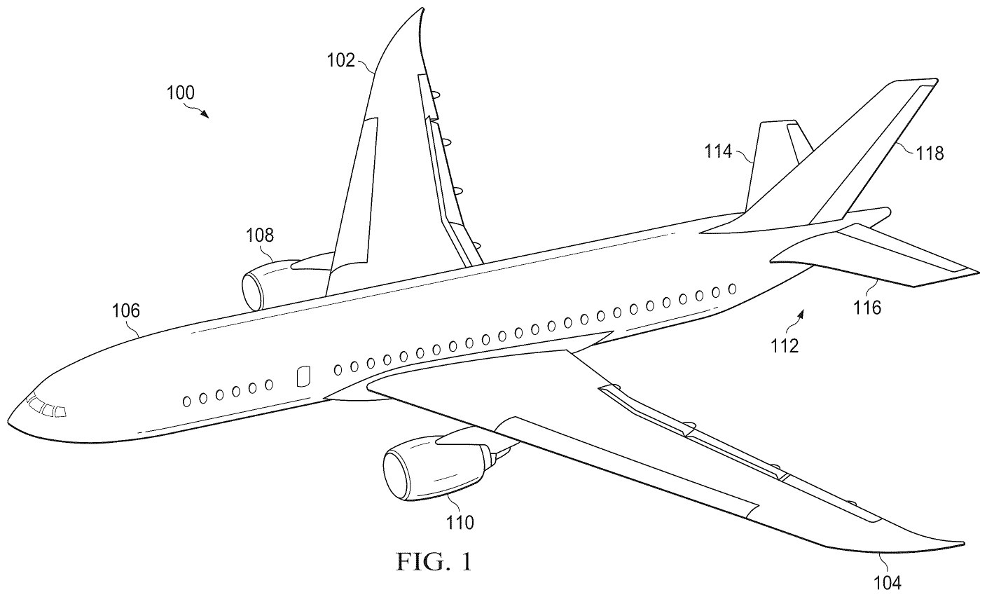

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have thermoplastic parts formed using inductive heating. For example, a thermoplastic component of any of wing 102 and wing 104, body 106, horizontal stabilizer 114, horizontal stabilizer 116, or vertical stabilizer 118 can be manufactured using a thermoplastic induction tool or methods of the illustrative examples.

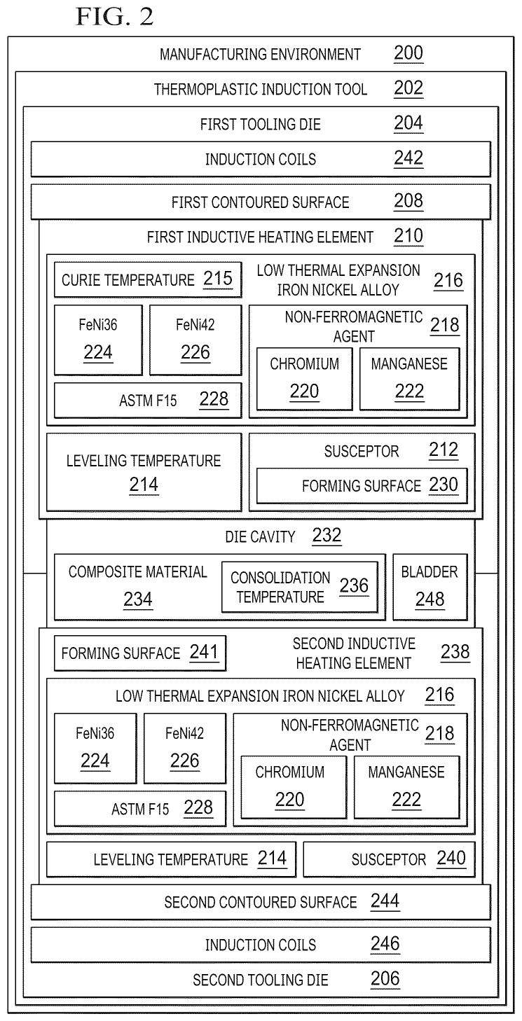

Turning now to FIG. 2, an illustration of a block diagram of a manufacturing environment is depicted in accordance with an illustrative embodiment. Thermoplastic induction tool 202 is present in manufacturing environment 200 to heat and form composite material 234.

Thermoplastic induction tool 202 comprises inductive heating element 210 formed of low thermal expansion iron nickel alloy 216 magnetically poisoned by non-ferromagnetic agent 218 to have leveling temperature 214 selected based on consolidation temperature 236 of composite material 234. Low thermal expansion iron nickel alloy 216 has a higher Curie temperature 215 than consolidation temperature 236 of composite material 234 without the addition of non-ferromagnetic agent 218.

The addition of non-ferromagnetic agent 218 is used to tailor leveling temperature 214 of low thermal expansion iron nickel alloy 216 for inductive heating element, first inductive heating element 210. The addition of non-ferromagnetic agent 218 to low thermal expansion iron nickel alloy 216 lowers leveling temperature 214. Non-ferromagnetic agent 218 is selected to lower leveling temperature 214 without undesirably affecting the thermal expansion of low thermal expansion iron nickel alloy 216. Non-ferromagnetic agent 218 is selected to lower leveling temperature 214 without undesirably affecting mechanical properties of low thermal expansion iron nickel alloy 216.

Non-ferromagnetic agent 218 can take the form of any elemental metal or alloy that lowers leveling temperature 214 of low thermal expansion iron nickel alloy 216 without undesirably affecting the thermal expansion of low thermal expansion iron nickel alloy 216. Strong magnetic poisoning metals or alloys can be initially identified to set possible materials to be chosen from in selecting non-ferromagnetic agent 218. However, the effects on leveling temperature 214 of low thermal expansion iron nickel alloy 216 based on percentage of non-ferromagnetic agent 218 are not predictable based solely on material properties of non-ferromagnetic agent 218. Due to its unpredictable nature, non-ferromagnetic agent 218 is not selected based solely on its strong magnetic poisoning potential.

In some illustrative examples, non-ferromagnetic agent 218 comprises one of chromium 220, manganese 222, or molybdenum. In some illustrative examples, non-ferromagnetic agent 218 comprises one of chromium 220 or manganese 222. An amount of non-ferromagnetic agent 218 is selected to tailor leveling temperature 214. In some illustrative examples, non-ferromagnetic agent 218 is selected such that a smallest amount of non-ferromagnetic agent 218 can be used. In some illustrative examples, the type of non-ferromagnetic agent 218 is selected such that a smallest volume of non-ferromagnetic agent 218 can be used to achieve leveling temperature 214. In some illustrative examples, non-ferromagnetic agent 218 comprises up to 0.5% chromium. In some illustrative examples, non-ferromagnetic agent 218 comprises up to 1.0% chromium. In some illustrative examples, non-ferromagnetic agent 218 comprises up to 2.5% chromium.

Low thermal expansion iron nickel alloy 216 can be selected from a variety of different alloy compositions. In some illustrative examples, low thermal expansion iron nickel alloy 216 is an iron nickel cobalt alloy. In some illustrative examples, cobalt containing smart susceptor alloys can exhibit a more responsive thermal control at the leveling temperature.

In some illustrative examples, low thermal expansion iron nickel alloy 216 is one of FeNi36 224, FeNi42 226, or ASTM F15 228. In some illustrative examples, low thermal expansion iron nickel alloy 216 is selected from Invar or Kovar. Low thermal expansion iron nickel alloy 216 is selected to provide a desirably low thermal expansion at consolidation temperature 236 of composite material 234. In some illustrative examples, FeNi42 is selected as it maintains its low thermal expansion properties into the higher processing temperatures used for thermoplastic composites.

Thermoplastic induction tool 202 further comprises first tooling die 204 and second tooling die 206 movable with respect to each other. First contoured surface 208 is provided on first tooling die 204 and second contoured surface 244 is provided on second tooling die 206. First contoured surface 208 and second contoured surface 244 configured to impart a curved contour to composite material 234. First inductive heating element 210 is connected to first contoured surface 208.

Second inductive heating element 238 is formed of low thermal expansion iron nickel alloy 216 magnetically poisoned by non-ferromagnetic agent 218 and connected to second contoured surface 244. As depicted, second inductive heating element 238 is formed of the same low thermal expansion iron nickel alloy and non-ferromagnetic agent as first inductive heating element 210, low thermal expansion iron nickel alloy 216 and non-ferromagnetic agent 218. In this illustrative example, first inductive heating element 210 and second inductive heating element 238 have leveling temperature 214.

In other non-depicted examples, first inductive heating element 210 and second inductive heating element 238 can be formed of different materials. In other non-depicted examples, inductive heating element 210 and second inductive heating element 238 can have different leveling temperatures.

In this illustrative example, first inductive heating element 210 provides forming surface 230 for forming composite material 234 in die cavity 232. In this illustrative example, second inductive heating element 238 provides second forming surface 241 for forming composite material 234 in die cavity 232.

Composite material 234 can be formed into any desirable shape. The shape of forming surface 230 and second forming surface 241 of first tooling die 204 and second tooling die 206 are configured to form composite material 234 to a desired cross-sectional shape. Composite material 234 can be formed into the dimensions of a spar, beam, panel, or other structural member. Composite material 234 can be formed into the shape of a component for an aircraft, such as aircraft 100 of FIG. 1.

In this illustrative example, bladder 248 is present in die cavity 232. Bladder 248 can be used to form composite material 234 with an enclosed shape.

First inductive heating element 210 generates heat when exposed to a magnetic field generated by induction coils 242. Second inductive heating element 238 generates heat when exposed to a magnetic field generated by induction coils 246.

In some illustrative examples, first inductive heating element 210 can be referred to as susceptor 212. In some illustrative examples, second inductive heating element 238 can be referred to as susceptor 240. Thermoplastic induction tool 202 comprises induction coils 242 and induction coils 246 magnetically coupled with susceptors, susceptor 212 and susceptor 240, to translate electrical power into heat energy.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, bladder 248 is optional. As another example, first inductive heating element 210 can be a part of a tool other than thermoplastic induction tool 202. In some illustrative examples, first inductive heating element 210 can be a part of a thermoset processing tool. In some illustrative examples, first inductive heating element 210 can be present in a tool without second inductive heating element 238.

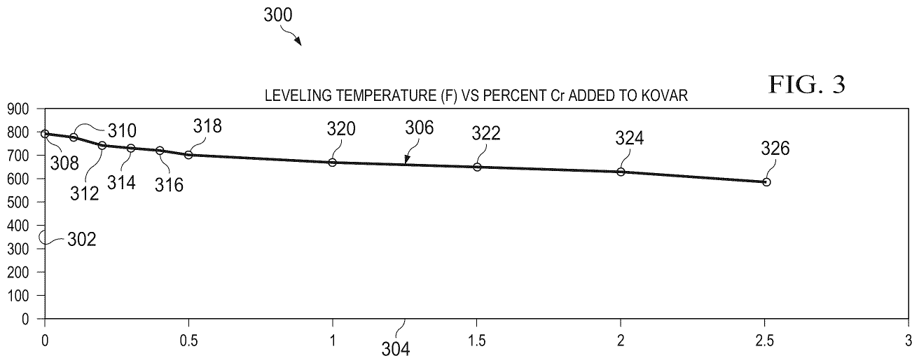

Turning now to FIG. 3, an illustration of a graph of the relationship between chromium and the leveling temperature of Kovar is depicted in accordance with an illustrative embodiment. Graph 300 can be a graph of leveling temperature 214 of low thermal expansion iron nickel alloy 216 with an addition of non-ferromagnetic agent 218. More specifically, graph 300 can be a graph of leveling temperature 214 after adding chromium 220 to ASTM F15 228.

Leveling temperature 302 is the Y-axis of graph 300 while percent chromium 304 is the X-axis. In ASTM F15 306, leveling temperature 302 decreases as percent chromium 304 increases. A small amount of chromium can be added for significant decreases to leveling temperature 302. Leveling temperature 308 without chromium is 785 degrees Fahrenheit.

Leveling temperature 310 with 0.1% chromium is approximately 770 degrees Fahrenheit. Leveling temperature 312 with 0.2% chromium is approximately 735 degrees Fahrenheit. Leveling temperature 314 with 0.3% chromium is approximately 725 degrees Fahrenheit.

Leveling temperature 316 with 0.4% chromium is approximately 715 degrees Fahrenheit. Leveling temperature 318 with 0.5% chromium is approximately 695 degrees Fahrenheit. Leveling temperature 320 with 1.0% chromium is approximately 665 degrees Fahrenheit. Leveling temperature 322 with 1.5% chromium is approximately 645 degrees Fahrenheit. Leveling temperature 324 with 2.0% chromium is approximately 625 degrees Fahrenheit. Leveling temperature 326 with 2.5% chromium is approximately 580 degrees Fahrenheit.

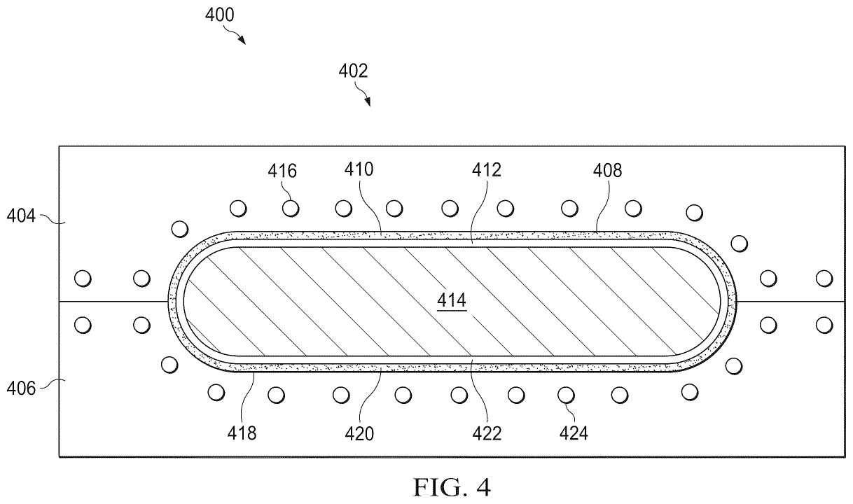

Turning now to FIG. 4, an illustration of a cross-sectional view of a thermoplastic induction tool having a susceptor with a non-ferromagnetic material is depicted in accordance with an illustrative embodiment. View 400 is a simplified image of thermoplastic induction tool 402.

Thermoplastic induction tool 402 can be used to form a composite material including a fibrous material and a matrix material to a desired configuration. For example, a composite material that is substantially flat can be formed to a predetermined configuration of a curved, bent, or otherwise contoured panel or structure.

Thermoplastic induction tool 402 comprises first tooling die 404 and second tooling die 406. First tooling die 404 and second tooling die 406 are co-operable and configured to define a die cavity 422 between first tooling die 404 and second tooling die 406. Die cavity 422 is structured to receive a composite material.

First tooling die 404 and second tooling die 406 are movable with respect to each other. First contoured surface 408 is provided on first tooling die 404. Second contoured surface 418 is provided on second tooling die 406. First contoured surface 408 and second contoured surface 418 are configured to impart a curved contour to a composite material. Inductive heating element 410 is connected to first contoured surface 408.

Inductive heating element 410 is formed of a low thermal expansion iron nickel alloy magnetically poisoned by a non-ferromagnetic agent to have a leveling temperature selected based on a consolidation temperature of a composite material. Inductive heating element 410 is a physical implementation of first inductive heating element 210 of FIG. 2.

Second inductive heating element 420 is formed of a low thermal expansion iron nickel alloy magnetically poisoned by the non-ferromagnetic agent. Second inductive heating element 420 is connected to second contoured surface 418. Second inductive heating element 420 is a physical implementation of second inductive heating element 238 of FIG. 2.

Although a thermoplastic material is generally discussed, thermoplastic induction tool 402 can be used to process any desirable composite material. The composite material can include any desirable fibrous material and any desirable matrix material. In some illustrative examples, the fibrous material can be graphite-based, fiberglass, alumina-based, boron-based, or silicon carbide-based fibers. In some illustrative examples, the fibers can be provided as plies in a weave, braid, or non-woven arrangement or as a sheet-like mat of material. In some illustrative examples, the matrix material can be a thermoplastic resin. In other illustrative examples, thermoset resins can be used, including any epoxy-based polymer.

In some illustrative examples, inductive heating element 410 and second inductive heating element 420 can be removed and replaced with other inductive heating elements. For example, for a different type of composite material with a different consolidation temperature, inductive heating element 410 and second inductive heating element 420 can be removed and replaced with inductive heating elements that have a leveling temperature of that different consolidation temperature.

Although a capsule shaped bladder, bladder 414 and die cavity 422 are depicted, the composite material can be formed into any desirable shape. For other composite material shapes, first tooling die 404 and second tooling die 406 would have differently shaped contoured surfaces. The composite material can be formed into the dimensions of a spar, beam, panel, or other structural member. The composite material can be formed into the shape of a component for an aircraft, such as aircraft 100 of FIG. 1. Composite material can be formed for other industries such as the automotive industry or a marine industry.

View 400 is a simplified view of thermoplastic induction tool 402 to depict locations of inductive heating element 410 and second inductive heating element 420. There are several components that are not depicted. For example, although not depicted, first tooling die 404 and second tooling die 406 can be generally mounted to and supported by strongbacks which may be secured using a mechanical support structure. There can be multiple actuators to move first tooling die and second tooling die. The actuators can take any desirable form, such as hydraulic, pneumatic, or electric rams. The actuators are configured to move the first tooling die toward or away from the second tooling die to open or close the die cavity.

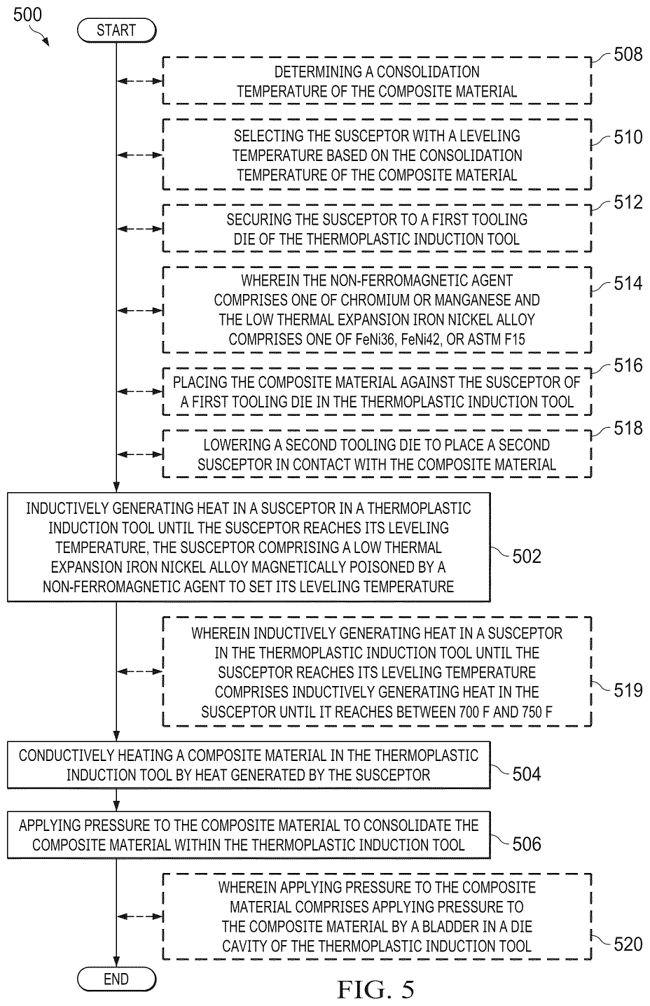

Turning now to FIG. 5, a flowchart of a method of forming a composite material is depicted in accordance with an illustrative embodiment. Method 500 can be used to form a component of aircraft 100 of FIG. 1. Method 500 can be performed using thermoplastic induction tool 202 of FIG. 2. Method 500 can be performed using a susceptor formed of a material with the leveling temperature behavior in graph 300 of FIG. 3. Method 500 can be performed using thermoplastic induction tool 402 of FIG. 4.

Method 500 inductively generates heat in a susceptor in a thermoplastic induction tool until the susceptor reaches its leveling temperature, the susceptor comprising a low thermal expansion iron nickel alloy magnetically poisoned by a non-ferromagnetic agent to set its leveling temperature (operation 502). Method 500 conductively heats a composite material in the thermoplastic induction tool by heat generated by the susceptor (operation 504). Method 500 applies pressure to the composite material to consolidate the composite material within the thermoplastic induction tool (operation 506). Afterwards, method 500 terminates.

In some illustrative examples, method 500 determines a consolidation temperature of the composite material (operation 508). The consolidation temperature is dependent upon the type of composite material.

In some illustrative examples, method 500 selects the susceptor with a leveling temperature based on the consolidation temperature of the composite material (operation 510). In some illustrative examples, method 500 secures the susceptor to a first tooling die of the thermoplastic induction tool (operation 512).

In some illustrative examples, the non-ferromagnetic agent comprises one of chromium or manganese and the low thermal expansion iron nickel alloy comprises one of FeNi36, FeNi42, or ASTM F15 (operation 514). The non-ferromagnetic agent tailors the leveling temperature of the susceptor. The non-ferromagnetic agent lowers the leveling temperature of the susceptor based on the consolidation temperature.

In some illustrative examples, method 500 places the composite material against the susceptor of a first tooling die in the thermoplastic induction tool (operation 516). In some illustrative examples, method 500 lowers a second tooling die to place a second susceptor in contact with the composite material (operation 518).

In some illustrative examples, inductively generating heat in the susceptor in the thermoplastic induction tool until the susceptor reaches its leveling temperature comprises inductively generating heat in the susceptor until it reaches between 700 F and 750 F (operation 519). In some illustrative examples, inductively generating heat in the susceptor in the thermoplastic induction tool until the susceptor reaches its leveling temperature comprises inductively generating heat in the susceptor until it reaches between 750 F and 780 F. In some illustrative examples, inductively generating heat in the susceptor in the thermoplastic induction tool until the susceptor reaches its leveling temperature comprises inductively generating heat in the susceptor until it reaches between 780 F and 800 F. In some illustrative examples, inductively generating heat in the susceptor in the thermoplastic induction tool until the susceptor reaches its leveling temperature comprises inductively generating heat in the susceptor until it reaches between 650 F and 750 F.

In some illustrative examples, applying pressure to the composite material comprises applying pressure to the composite material by a bladder in a die cavity of the thermoplastic induction tool (operation 520). In some illustrative examples, applying pressure to the composite material comprises applying pressure to the composite material by the first tooling die and the second tooling die.

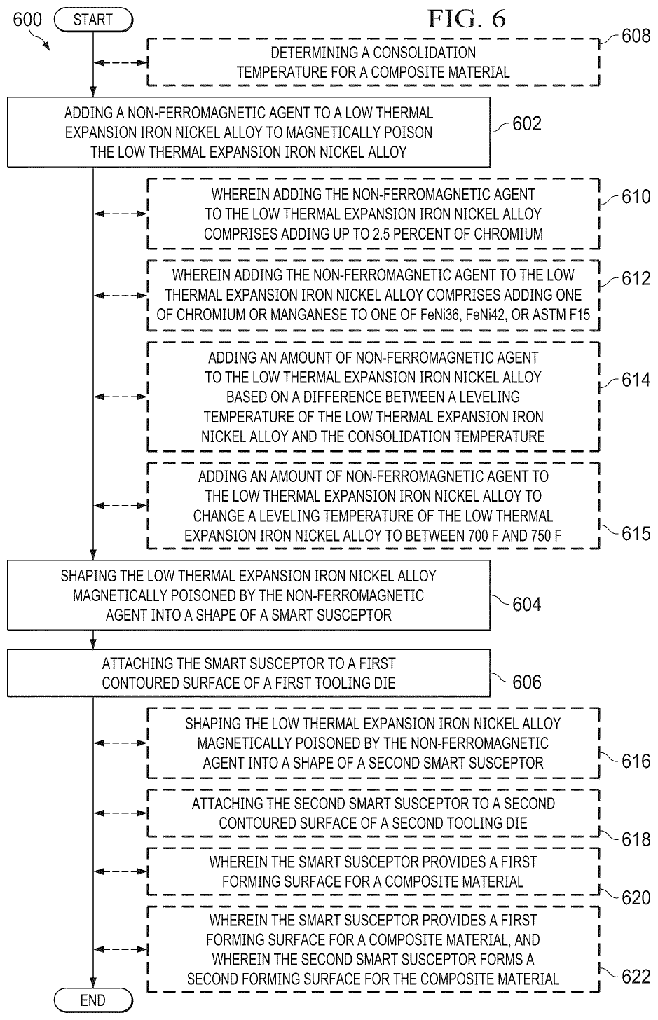

Turning now to FIG. 6, a flowchart of a method of forming a thermoplastic induction tool is depicted in accordance with an illustrative embodiment. Method 600 can be used to form a thermoplastic induction tool that can be used for manufacturing components of aircraft 100 of FIG. 1. Method 600 can be performed to form thermoplastic induction tool 202 of FIG. 2. Method 600 can be performed to form a thermoplastic induction tool with a susceptor formed of a material with the leveling temperature behavior in graph 300 of FIG. 3. Method 600 can be performed to form thermoplastic induction tool 402 of FIG. 4.

Method 600 adds a non-ferromagnetic agent to a low thermal expansion iron nickel alloy to magnetically poison the low thermal expansion iron nickel alloy (operation 602). Method 600 shapes the low thermal expansion iron nickel alloy magnetically poisoned by the non-ferromagnetic agent into a shape of a smart susceptor (operation 604). Method 600 attaches the smart susceptor to a first contoured surface of a first tooling die (operation 606). Afterwards, method 600 terminates.

In some illustrative examples, method 600 determines a consolidation temperature for a composite material (operation 608). In some illustrative examples, adding the non-ferromagnetic agent to the low thermal expansion iron nickel alloy comprises adding up to 2.5% of chromium (operation 610). In some other illustrative examples, the non-ferromagnetic agent comprises up to 0.5% chromium. In some other illustrative examples, the non-ferromagnetic agent comprises up to 1.0% chromium. In some other illustrative examples, non-ferromagnetic agent comprises up to 2.0% chromium.

In some illustrative examples, adding the non-ferromagnetic agent to the low thermal expansion iron nickel alloy comprises adding one of chromium or manganese to one of FeNi36, FeNi42, or ASTM F15 (operation 612). In some illustrative examples, the low thermal expansion iron nickel alloy is one of Invar or Kovar.

In some illustrative examples, method 600 adds an amount of non-ferromagnetic agent to the low thermal expansion iron nickel alloy based on a difference between a leveling temperature of the low thermal expansion iron nickel alloy and the consolidation temperature (operation 614). In some illustrative examples, method 600 adds an amount of non-ferromagnetic agent to the low thermal expansion iron nickel alloy to change a leveling temperature of the low thermal expansion iron nickel alloy to between 700 F and 750 F (operation 615).

In some illustrative examples, method 600 shapes the low thermal expansion iron nickel alloy magnetically poisoned by the non-ferromagnetic agent into a shape of a second smart susceptor (operation 616). In some illustrative examples, method 600 attaches the second smart susceptor to a second contoured surface of a second tooling die (operation 618).

In some illustrative examples, the smart susceptor provides a first forming surface for a composite material (operation 620). In some illustrative examples, the smart susceptor provides a first forming surface for a composite material, and wherein the second smart susceptor forms a second forming surface for the composite material (operation 622).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 508 through operation 520 may be optional. As another example, operation 608 through operation 622 may be optional.

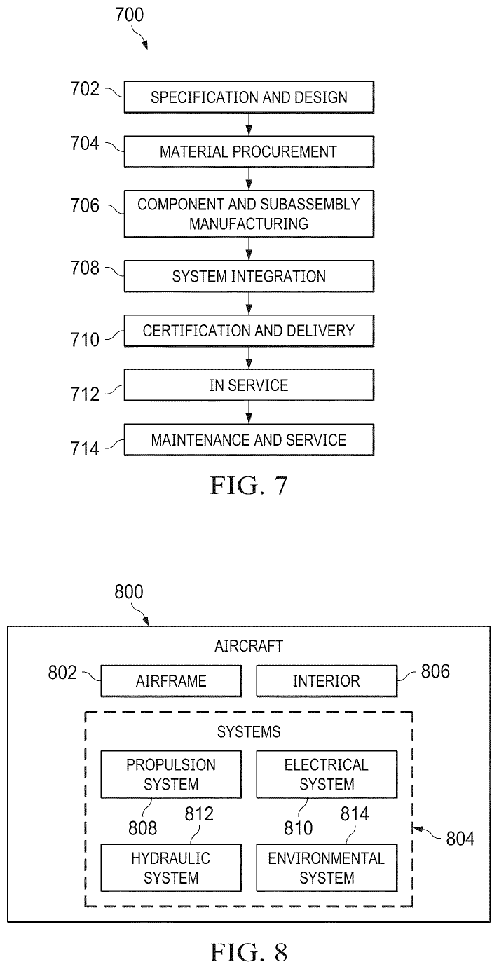

Illustrative embodiments of the present disclosure may be described in the context of aircraft manufacturing and service method 700 as shown in FIG. 7 and aircraft 800 as shown in FIG. 8. Turning first to FIG. 7, an illustration of an aircraft manufacturing and service method in a form of a block diagram is depicted in accordance with an illustrative embodiment. During pre-production, aircraft manufacturing and service method 700 may include specification and design 702 of aircraft 800 in FIG. 8 and material procurement 704.

During production, component and subassembly manufacturing 706 and system integration 708 of aircraft 800 takes place. Thereafter, aircraft 800 may go through certification and delivery 710 in order to be placed in service 712. While in service 712 by a customer, aircraft 800 is scheduled for routine maintenance and service 714, which may include modification, reconfiguration, refurbishment, or other maintenance and service.

Each of the processes of aircraft manufacturing and service method 700 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 8, an illustration of an aircraft in a form of a block diagram is depicted in which an illustrative embodiment may be implemented. In this example, aircraft 800 is produced by aircraft manufacturing and service method 700 of FIG. 7 and may include airframe 802 with plurality of systems 804 and interior 806. Examples of systems 804 include one or more of propulsion system 808, electrical system 810, hydraulic system 812, and environmental system 814. Any number of other systems may be included.

Apparatuses and methods embodied herein may be employed during at least one of the stages of aircraft manufacturing and service method 700. One or more illustrative embodiments may be manufactured or used during at least one of component and subassembly manufacturing 706, system integration 708, in service 712, or maintenance and service 714 of FIG. 7.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A thermoplastic induction tool comprising:
an inductive heating element formed of a low thermal expansion iron nickel alloy magnetically poisoned by a non-ferromagnetic agent to have a leveling temperature selected based on a consolidation temperature of a composite material.

2. The thermoplastic induction tool of claim 1, wherein the low thermal expansion iron nickel alloy is an iron nickel cobalt alloy.

3. The thermoplastic induction tool of claim 1, wherein the low thermal expansion iron nickel alloy is one of FeNi36, FeNi42, or ASTM F15.

4. The thermoplastic induction tool of claim 1, wherein the non-ferromagnetic agent comprises one of chromium or manganese.

5. The thermoplastic induction tool of claim 1, wherein the non-ferromagnetic agent comprises up to 2.5% chromium.

6. The thermoplastic induction tool of claim 1 further comprising:
a first tooling die and a second tooling die movable with respect to each other; and a first contoured surface provided on the first tooling die and a second contoured surface provided on the second tooling die, the first contoured surface and the second contoured surface configured to impart a curved contour to a composite material, wherein the inductive heating element is connected to the first contoured surface.

7. The thermoplastic induction tool of claim 6 further comprising:
a second inductive heating element formed of the low thermal expansion iron nickel alloy magnetically poisoned by the non-ferromagnetic agent and connected to the second contoured surface.

8. A method of forming a composite material comprising:
inductively generating heat in a susceptor in a thermoplastic induction tool until the susceptor reaches its leveling temperature, the susceptor comprising a low thermal expansion iron nickel alloy magnetically poisoned by a non-ferromagnetic agent to set its leveling temperature;
conductively heating a composite material in the thermoplastic induction tool by heat generated by the susceptor; and
applying pressure to the composite material to consolidate the composite material within the thermoplastic induction tool.

9. The method of claim 8 further comprising:
placing the composite material against the susceptor of a first tooling die in the thermoplastic induction tool; and
lowering a second tooling die to place a second susceptor in contact with the composite material.

10. The method of claim 8 further comprising:
determining a consolidation temperature of the composite material; and
selecting the susceptor with a leveling temperature based on the consolidation temperature of the composite material; and
securing the susceptor to a first tooling die of the thermoplastic induction tool.

11. (canceled)

12. The method of claim 8, wherein applying pressure to the composite material comprises applying pressure to the composite material by a bladder in a die cavity of the thermoplastic induction tool.

13. The method of claim 8, wherein inductively generating heat in the susceptor in the thermoplastic induction tool until the susceptor reaches its leveling temperature comprises inductively generating heat in the susceptor until it reaches between 700 F and 750 F.

14. A method of forming a thermoplastic induction tool comprising:
adding a non-ferromagnetic agent to a low thermal expansion iron nickel alloy to magnetically poison the low thermal expansion iron nickel alloy;
shaping the low thermal expansion iron nickel alloy magnetically poisoned by the non-ferromagnetic agent into a shape of a smart susceptor; and
attaching the smart susceptor to a first contoured surface of a first tooling die.

15. The method of claim 14 further comprising:
shaping the low thermal expansion iron nickel alloy magnetically poisoned by the non-ferromagnetic agent into a shape of a second smart susceptor; and
attaching the second smart susceptor to a second contoured surface of a second tooling die.

16. The method of claim 14, wherein the smart susceptor provides a first forming surface for a composite material.

17. The method of claim 15, wherein the smart susceptor provides a first forming surface for a composite material, and wherein the second smart susceptor forms a second forming surface for the composite material.

18. The method of claim 14 further comprising:
determining a consolidation temperature for a composite material; and
adding an amount of non-ferromagnetic agent to the low thermal expansion iron nickel alloy based on a difference between a leveling temperature of the low thermal expansion iron nickel alloy and the consolidation temperature.

19. The method of claim 14, wherein adding the non-ferromagnetic agent to the low thermal expansion iron nickel alloy comprises adding up to 2.5% of chromium.

20. The method of claim 14, wherein adding the non-ferromagnetic agent to the low thermal expansion iron nickel alloy comprises adding one of chromium or manganese to one of FeNi36, FeNi42, or ASTM F15.

21. The method of claim 14 further comprising: adding an amount of non-ferromagnetic agent to the low thermal expansion iron nickel alloy to change a leveling temperature of the low thermal expansion iron nickel alloy to between 700 F and 750 F.
